(19) United States
(12) Patent Application Publication
(10) Pub. No.: US 2007/0179940 A1
(43) Pub. Date: Aug. 2, 2007

(54) System and method for formulating data search queries

(76) Inventors: Eric M. Robinson, Bellevue, WA (US); Edward L. Walter, Bainbridge Island, WA (US)

Correspondence Address: CASCADIA INTELLECTUAL PROPERTY, 500 UNION STREET, SUITE 1005, SEATTLE, WA, 98101, US

(21) Appl. No.: 11/341,128

(22) Filed: Jan. 27, 2006

(51) Int. Cl. G06F 17/30

(52) U.S. Cl. 707/4

(57) ABSTRACT

A system and method for formulating data search queries is presented. A user interface operable to specify an unstructured search criteria for a search query on one or more documents is provided. An input portal is exported to receive a data excerpt selected to be searched against the documents. A selectable inclusiveness control is exported to specify a granularity of inclusion of matching tokens within each document. A selectable proximity control is exported to specify a degree of nearness of the tokens within each document. Tokens derived from the data excerpt and parameters corresponding to the granularity of inclusion and the degree of nearness are compiled into the search query.

### FIELD OF THE INVENTION

The invention relates in general to data searching and, specifically, to a system and method for formulating data search queries.

### BACKGROUND OF THE INVENTION

An increasingly substantial body of printed material in electronic form has evolved in large part due to the widespread adoption of the Internet and personal computing. These materials include both traditional “formal” forms of writings and publications distributed through publishers, businesses, governmental agencies, and educational institutions, such as books, manuscripts, and other published materials, and non-traditional “informal” works, such as email, personal correspondence, notes, instant messaging, and other textual and non-textual content stored in electronic form. Additionally, other materials stored in electronic form include non-traditionally authored binary and non-character-based data, such as object and various forms of program code generated by computer program compilers.

Efficient search strategies have long existed for databases, spreadsheets, object libraries, and similar structured and ordered data. In contrast, authored, non-machine originated documents, such as textual content, are unstructured collections of words that lack a regular ordering amenable to search. As a result, conventional searching tools for such content borrow from ordered data search techniques and rely on algebraic formulations using Boolean logic or query languages, such as SQL. Individual terms are combined into search queries using Boolean logic operators, such as AND for conjunction, OR for disjunction, and NOT for negation, and the search scope is specified through set complementation and union operations on the target corpus and interim search results. Matching documents, or “hits,” are presented for review or further searching.

For most users, searching using Boolean logic or query languages is non-intuitive and may provide incorrect or undesired search results. Natural language search tools attempt to insulate users from working directly with Boolean logic or query languages by providing a user-friendly front-end through which search queries can be specified as simple English language sentences or phrases. Often, a query is entered as a question or phrase, which is parsed and processed by a front-end processor. An underlying search engine then attempts to identify target documents implied by the literal and linguistic structure of the search query.

Boolean logic, query languages, and natural language search tools, though, require users to formulate and enter an express search criteria, either as a Boolean or query language expression, or as a natural language sentence or phrase. Users must concentrate on how the phrasing of the search criteria might affect the search and are forced to reevaluate the criteria when the search results are non-responsive. Searching through documents, however, does not always translate easily into readily-expressible criteria, and re-searching can be time-consuming and counter-productive. Thus, a less structured form of searching that can accommodate unstructured, preferably expressionless, search criteria is sometimes needed. For example, a user might have a general idea that a set of documents likely contains phraseology that “sort of” matches, but does not exactly match, a particular data excerpt. Conventional search tools require the user to first evaluate the data excerpt to identify potentially matching search terms and conditions, yet determining the proper terms and conditions to include or exclude in the criteria might require multiple attempts until desired results are obtained. For instance, specifying the proximity, or nearness, of matching terms within each document can relax or constrain the search scope, but knowing how far to span search term proximity generally assumes a priori knowledge of the structure of the target documents, such as word ordering and frequency.

Therefore, there is a need for an approach to facilitating searching of textual and non-textual data through a user interface that accepts unstructured data and user-adjustable search criteria parameters to specify, for example, variable term inclusion and proximity of matching search terms.

### SUMMARY OF THE INVENTION

A system and method includes a user interface that allows a user to specify an unstructured search criteria for documents by providing a data excerpt, including textual or binary data, and choosing parameters indicating search term inclusion and proximity of matching terms. The documents contain data, which can be character-based or pure binary stored data, and are indexed for use in searching and other data processing activities. The user interface formulates a search query for the user and does not require the search criteria to be explicitly defined by the user. Instead, the user provides a data excerpt and adjusts inclusion and proximity controls. The data excerpt is parsed and processed to extract search terms, which become tokens in the search query. The adjustments to the inclusion control define the minimum number of search terms that must appear in each document being searched, which always requires one or more matching terms. The adjustments to the proximity control define the span within which a minimum of two or more matching search terms must appear. For instance, two matching search terms occurring next to each other have a span equal to zero.

One embodiment provides a system and method for formulating data search queries. A user interface operable to specify an unstructured search criteria for a search query on one or more documents is provided. An input portal is exported to receive a data excerpt selected to be searched against the documents. A selectable inclusiveness control is exported to specify a granularity of inclusion of matching tokens within each document. A selectable proximity control is exported to specify a degree of nearness of the tokens within each document. Tokens derived from the data excerpt and parameters corresponding to the granularity of inclusion and the degree of nearness are compiled into the search query.

A further embodiment provides a system and method for performing a data search. A data excerpt selected to be searched against one or more documents stored in electronic form is processed into search terms. A search criteria containing the search terms and parameters indicating at least one of search term inclusion and proximity of matching search terms in the documents is built. Search results generated by execution of the search criteria on the documents are presented.

Still other embodiments will become readily apparent to those skilled in the art from the following detailed description, wherein are described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing a system for formulating data search queries, in accordance with one embodiment.

FIG. 2 is a block diagram showing, by way of example, a set of documents stored in electronic form.

FIG. 3 is a screen diagram showing, by way of example, a user interface for use in the system of FIG. 1.

FIG. 4 is a process flow diagram showing intuitive data searching using the user interface of FIG. 3.

FIG. 5 is a flow diagram showing a method for formulating data search queries, in accordance with one embodiment.

FIG. 6 is a flow diagram showing a routine for preprocessing a search for use with the method of FIG. 5.

FIG. 7 is a flow diagram showing a routine for searching by nearness for use with the method of FIG. 5.

FIG. 8 is a flow diagram showing a routine for searching by inclusion for use with the method of FIG. 5.

FIG. 9 is a block diagram showing the system modules for implementing the document searcher of FIG. 1.

### DETAILED DESCRIPTION

System

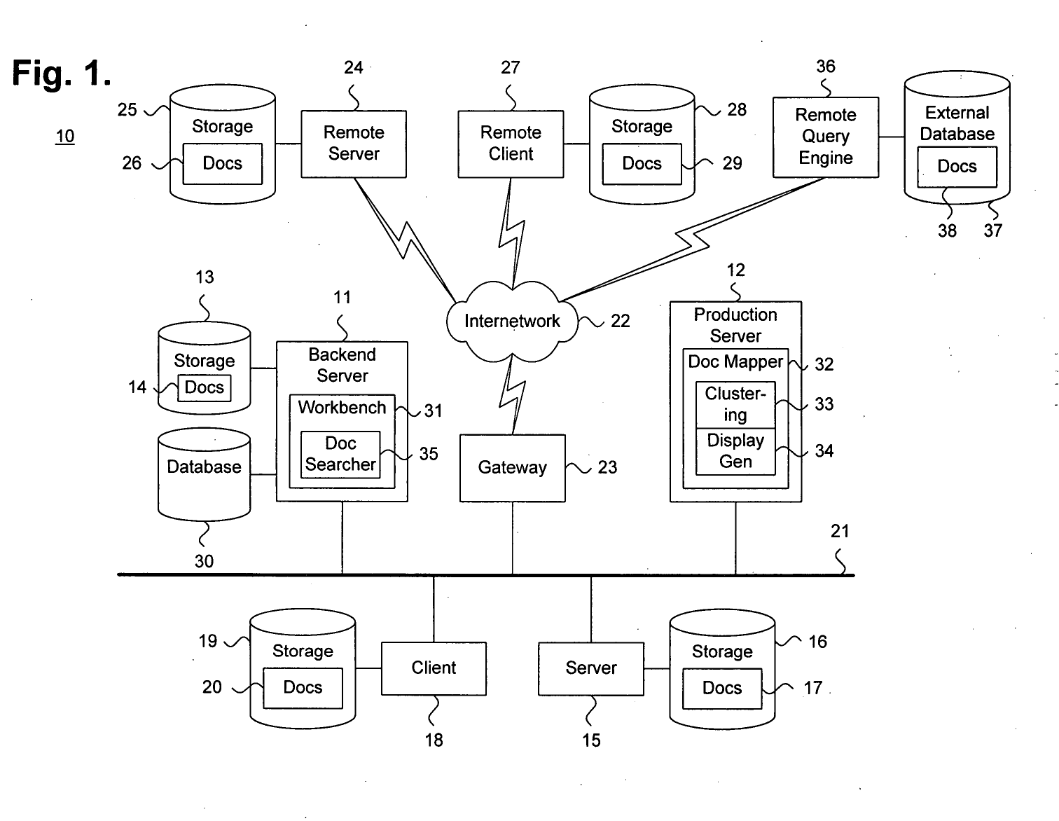

Documents stored in electronic form can be intuitively searched through a user-friendly interface that accepts unstructured data search criteria. FIG. 1 is a block diagram showing a system 10 for formulating data search queries, in accordance with one embodiment. Although searching unstructured informal documents is described herein, searchable documents can include all forms and manner of materials stored in electronic form that include both formal writings and publications, such as books, manuscripts, and other published materials; informal works, such as email, personal correspondence, notes, instant messaging, and other textual content stored in electronic form; and organized character-based or non-character-based binary data, such as stored in spreadsheets, databases, or object libraries.

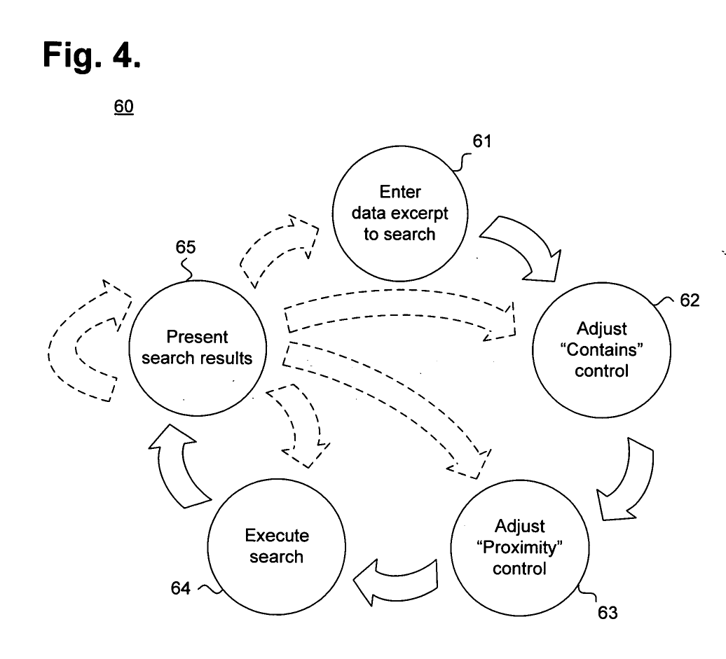

By way of illustration, the system 10 operates in a distributed computing environment, which includes a plurality of heterogeneous systems and document sources. A backend server 11 executes a workbench suite 31 for providing a user interface framework for automated document management and processing, which includes a document searcher 35 for searching documents 14 through an intuitive user interface, as further described below beginning with FIG. 4. The backend server 11 is coupled to a storage device 13, which stores the documents 14, in the form of structured or unstructured data, and a local database 30 for maintaining document information. A production server 12 includes a document mapper 32, that includes a clustering engine 33 and display generator 34. The clustering engine 33 performs efficient document scoring and clustering, such as described in commonly-assigned U.S. Pat. No. 6,778,995, issued Aug. 17, 2004, the disclosure of which is incorporated by reference. The display generator 34 arranges concept clusters in a radial thematic neighborhood relationships projected onto a two-dimensional visual display, such as described in commonly-assigned U.S. Pat. No. 6,888,548, issued May 3, 2005; U.S. patent application Ser. No. 10/778,416, filed Feb. 13, 2004, pending; U.S. patent application Ser. No. 10/911,375, filed Aug. 3, 2004, pending; and U.S. patent application Ser. No. 11/044,158, filed Jan. 26, 2005, pending, the disclosures of which are incorporated by reference.

The document mapper 32 operates on documents retrieved from a plurality of local or remote sources. The local sources include documents 17, 20 maintained in storage devices 16, 19 respectively coupled to a local server 15 or local client 18. The local server 15 and local client 18 are interconnected to the production system 11 over an intranetwork 21. In addition, the document mapper 32 can identify and retrieve documents from remote sources via a gateway 23 or similar portal to an internetwork 22, including the Internet. The remote sources include documents 26, 29 maintained in storage devices 25, 28 respectively coupled to a remote server 24 and a remote client 27. In one embodiment, the documents 17, 20, 26, 29 include email stored in electronic message folders, such as maintained by the Outlook and Outlook Express products, licensed by Microsoft Corporation, Redmond, Wash. In a further embodiment, the document searcher 35 provides an interface to an external query engine 36 that executes search queries on either the local database 30 or a remote database 37 and provides back search results. The databases 30, 37 can be SQL-based relational databases, such as the Oracle database management system, Release 8, licensed by Oracle Corporation, Redwood Shores, Calif., or other types of structured databases. Other system environments, network configurations and topologies, and sources of documents and electronically-stored data are possible.

The individual computer systems, including backend server 11, production server 32, server 15, client 18, remote server 24, remote client 27, and remote query engine 36 are general purpose, programmed digital computing devices consisting of a central processing unit (CPU), random access memory (RAM), non-volatile secondary storage, such as a hard drive or CD ROM drive, network interfaces, and peripheral devices, including user interfacing means, such as a keyboard and display. Program code, including software programs, and data are loaded into the RAM for execution and processing by the CPU and results are generated for display, output, transmittal, storage, or processing.

Searching

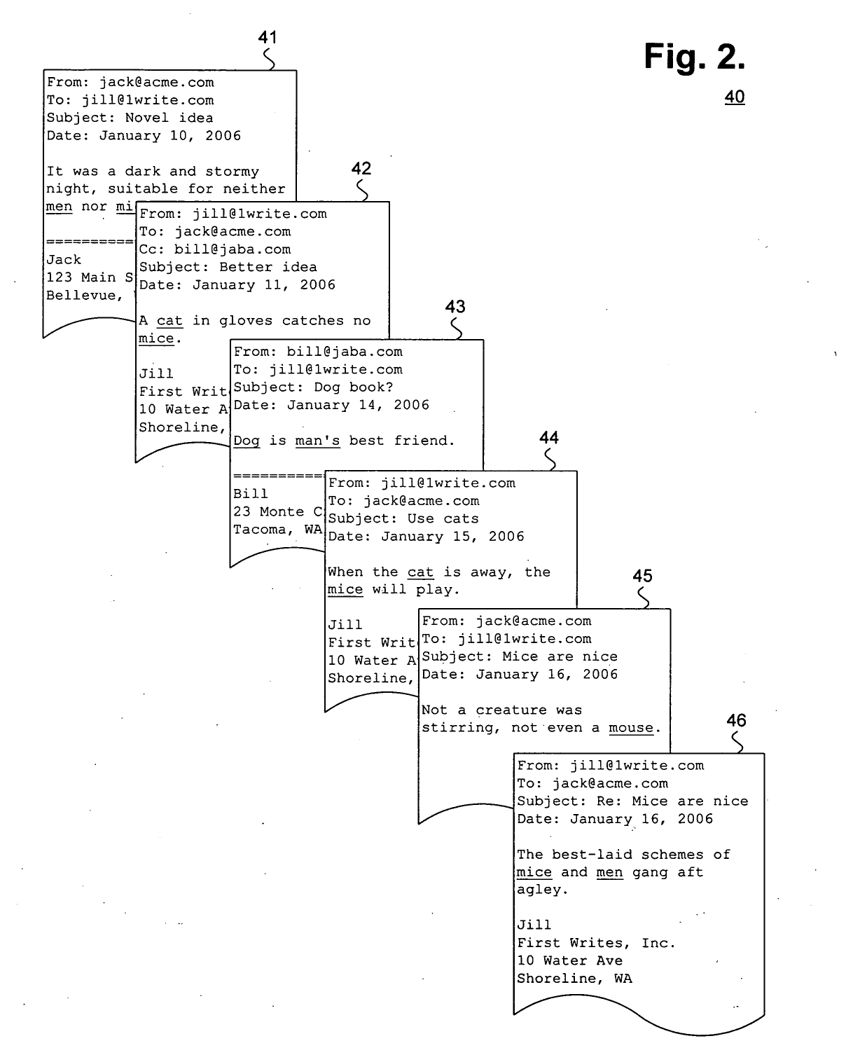

Email is one popular form of communications that results in unstructured informal writings and individual email messages can be treated as documents. Other forms and manner of documents are possible. FIG. 2 is a block diagram showing, by way of example, a set of documents 40 stored in electronic form, which contains individual emails 41-46 maintained by an email client application. Individual words in each email 41-46 can be extracted and formed into an index to facilitate searching and other data processing operations.

The substantive portions of each email 41-46, in particular, the message body with header and extraneous data removed, represent a collection of searchable data. For ease of discussion, pertinent words are underlined. For instance, emails 41, 42, 44, 45, and 46 all contain either “mice” or “mouse,” the root word stem of which is simply “mouse.” Similarly, emails 42 and 43 both contain “cat;” emails 41, 43 and 46 contain “man” or “men,” the root word stem of which is “man;” and email 43 contains “dog.” These words are indexed. By extension, searchable data occurring in all forms and manner of materials stored in electronic form can be identified and indexed to facilitate searching.

In a further embodiment, weights can be assigned to searchable data based on structural location within each document. For example, those words occurring in titles, heading, tables of content, or indexes can have higher weights assigned, which cause a search to favor those terms over other terms having lower weights, either assigned or by default.

User Interface

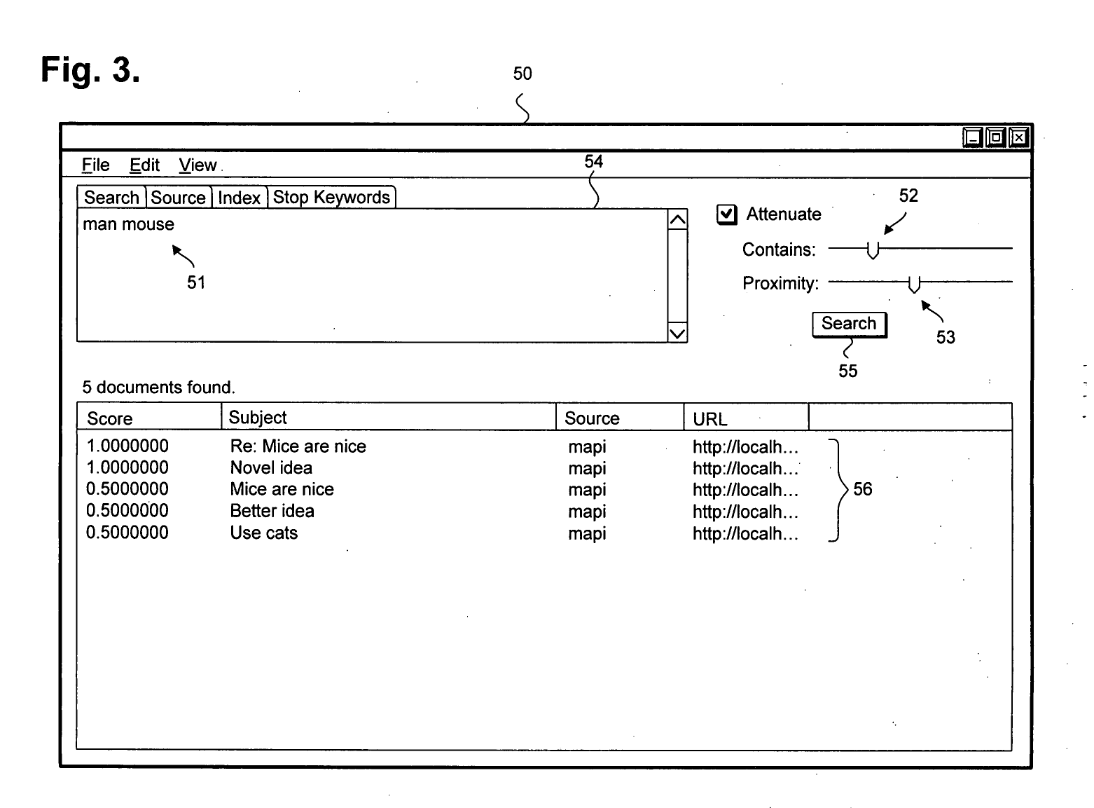

Rather than requiring users to construct complex search criteria, users need only provide an excerpt of data and user-adjustable selection controls to perform searching. FIG. 3 is a screen diagram showing, by way of example, a user interface 50 for use in the system 10 of FIG. 1. In one embodiment, the user interface 50 is generated as a graphical user interface by the document searcher 35, but could be provided through a text-only user interface. In addition, the user interface 50 could be generated by a system separate from the document searcher 35, so long as the necessary data excerpt and control inputs are available and a destination for the search results is supplied.

Searching is facilitated through operations performed on the user interface 50. FIG. 4 is a process flow diagram showing intuitive data searching using the user interface 50 of FIG. 3. A user can specify an unstructured search criteria by providing a data excerpt 51 and inputs to selectable user-adjustable controls. In one embodiment, two controls are provided for specifying term inclusion, “Contains” control 52, and nearness, “Proximity” control 53, searching, such as described further below in the Appendix. Other controls are possible.

Conceptually, search criteria specification and search query execution are two logically separate but operationally contiguous actions, that is, once a search criteria is specified, search query execution will follow. The search criteria is specified when the data excerpt 51 is entered (operation 61), when the “Contains” control is adjusted (operation 62), or when the “Proximity” control is adjusted (operation 63). Logically, these operations occur on the “half-click,” that is, upon the initial toggle of an input key, such as a mouse or keyboard button. The search query is executed (operation 64) upon the next “half-click,” that is, upon the release of the input key. In one embodiment, this pair of half-click operations is atomic, and actual search criteria processing and query execution can both occur following input key release, although the two operations could also be performed serially following detection of each separate half-click, where supported by the input key device drivers.

The data excerpt 51 is entered through a data entry area 54 (operation 61), such as by cut-and-paste or drag-and-drop commands, or through manual entry. In addition, the data excerpt 51 can include a Uniform Resource Location (URL), files, directories, folders, entire document, socket, data pipe, or other data stream or source. The data excerpt 51 is preprocessed into tokens for the search query, as further described below respectively with reference to FIG. 6. The data entry area 54 defines an input portal to receive the data excerpt, which can be provided in textual, binary, spoken, or other forms, including electronic. In one embodiment, the data excerpt 51 includes textual or binary data. In a further embodiment, data excerpt 51 can include an encapsulated search query, appropriately delimited and written in Boolean logic, a query language, and a natural language search tool grammar. Other types of data excerpts are possible.

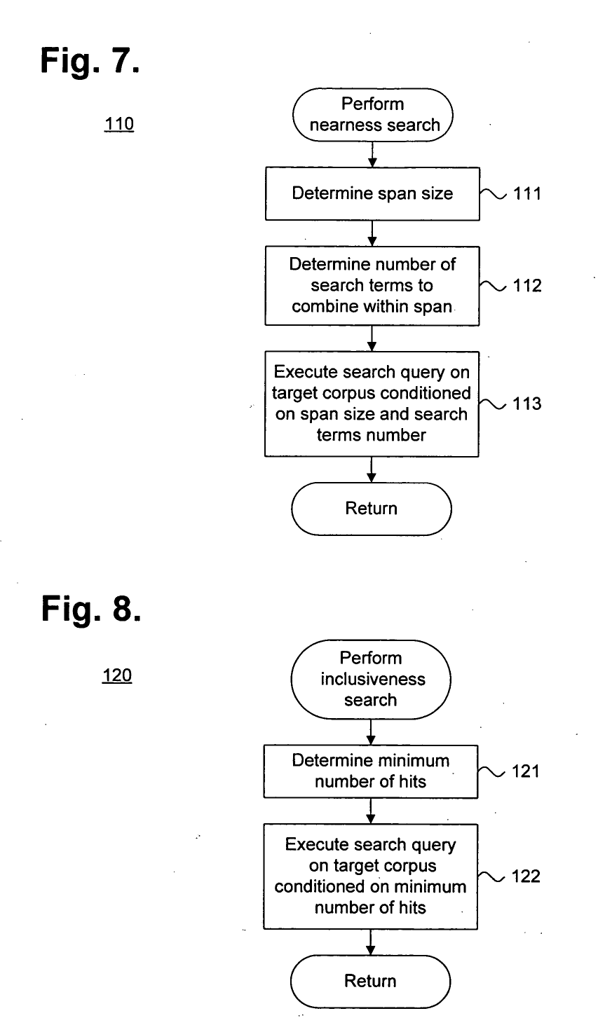

The user can also set search criteria parameters through selectable user-adjustable controls. The granularity by which search terms must be included within each document can be specified by adjusting the “Contains” control 52 (operation 62), as further described below respectively with reference to FIG. 7. The degree of nearness for matching search terms can be specified by adjusting the “Proximity” control 53 (operation 63), as further described below respectively with reference to FIG. 8. The “Contains” control 52 specifies a minimum of one search term, that is, each matching document must contain at least one matching term. The “Proximity” control 53 specifies a minimum value of two, that is, each matching document must contain at least two matching terms within each span or window. For example, two matching search terms occurring next to each other have a span equal to zero. Adjustments to the “Contains” control 52 and the “Proximity” control 53 can be performed for only one of the controls 52, 53 or for both controls 52, 53 in any order.

In one embodiment, the “Contains” control 52 and “Proximity” control 53 are separate user-adjustable slider bar controls, but could be a single selectable control. When set at either extreme of the range of control permitted with the “Contains” control 52 and “Proximity” control 53, respective granularity of inclusion and degree of nearness are maximally relaxed or constrained. Other types of controls for the “Contains” control 52 and “Proximity” control 53 are possible, including separate or combined rotary or gimbal knobs, slider bars, radio buttons, and other user input mechanisms that allow continuous or discrete selection over a fixed range of rotation, movement, or selection.

In a further embodiment, the user interface 50 can be supplemented with controls to specify additional search criteria. For example, a selection control can be provided to enable a user to specify one or more required or optional search terms in the data excerpt 51, which respectively qualifies the search to always and permissibly include the terms selected. Also, the user interface 50 can include an ordering control that allows a user to specify a precedence applicable to the search terms, which causes the search to favor those search terms having higher precedence over other terms. As well, the user interface 50 can include a search scope control that enables a user to specify those documents within the corpus to be searched, which limits the field of search to the documents specified. Other forms of user interface controls and options are possible.

The search query that is used to conduct the search of the corpus of target documents is compiled following search criteria specification (operations 61, 62, 63). In one embodiment, the search query is a combination of tokens and Boolean AND, OR, set, and similar operations, which specify the search logic for inclusiveness, and natural language sentences or phrases, which specify the search logic for proximity. In a further embodiment, the search query is a combination of an unstructured search criteria entered through the user interface 50, plus an encapsulated search query, which can also be entered through the user interface 50 via the data entry area 54. The encapsulated search query is concatenated or incorporated into the compiled search query.

The search query is automatically executed following search criteria specification or when the user toggles a search button 55 (operation 64). The search query is executed against target documents stored in a data corpus. Each document in the data corpus is indexed to facilitate searching. One form of suitable indexing based on feature extraction and scoring is described in commonly-assigned U.S. patent application, Ser. No. 10/317,438, filed on Dec. 11, 2002, pending, the disclosure of which is incorporated by reference. Other types of indexing are possible.

Those documents matching the search criteria are presented as search results 56 (operation 65). The search results 56 identify the emails 41, 46 scoring equally in terms of the inclusion of the terms “man” and “mouse.” These terms are also equally proximate with both terms occurring within one word of the other. The remaining emails 42, 44, 45 in the search results are lower scoring than the emails 41 and 46, but are equally likely between themselves. Proximity is inapplicable to these single term matches. The user can review the search results and perform further searching operations, including entering a data excerpt 51 (operation 61), adjusting the “Contains” control 52 (operation 62), adjusting the “Proximity” control 53 (operation 63), or executing a search (operation 64). In a further embodiment, the search results can be processed to facilitate review, including sorting, filtering, and organizing.

Method

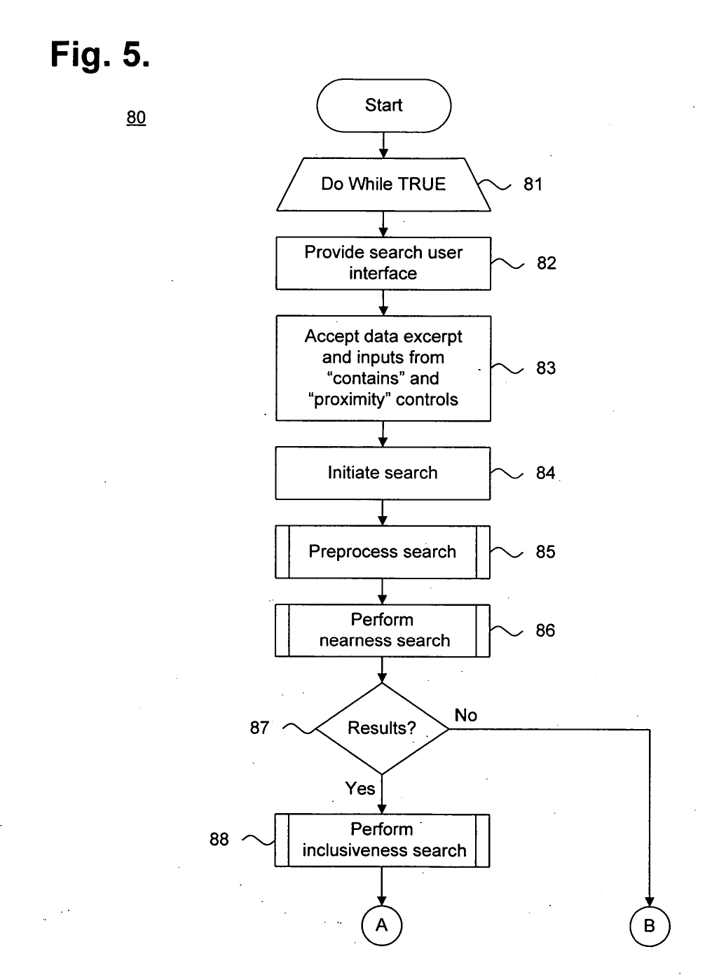

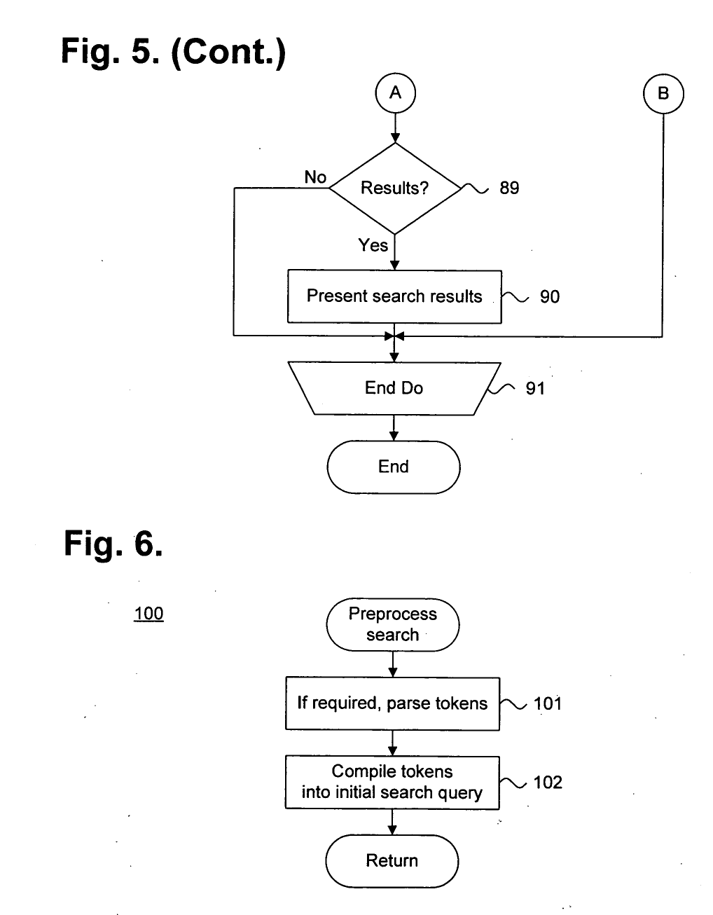

From a user perspective, searching requires providing a data excerpt 51 and adjusting the “Contains” and “Proximity” controls 52, 53 through the user interface 50. However, the raw user-specified search criteria must still be evaluated and executed as a search query to generate search results. Search criteria evaluation and execution can be performed as operations either as part of or independent from the user interface 50. FIG. 5 is a flow diagram showing a method 80 for formulating data search queries, in accordance with one embodiment. The method 80 is performed continuously in the background (blocks 81-91) whenever the user interface 50 is accessed, such as through entry of a data excerpt 51 or by adjustment of the “Contains” and “Proximity” controls 52, 53.

During each iteration, that is, search (block 81), the user interface 50 is first provided (block 82) and the data excerpt 51 and inputs to the “Contains” and “Proximity” controls 52, 53 are accepted (block 83). The search criteria is specified when the data excerpt 51 is entered, when the “Contains” control is adjusted, or when the “Proximity” control is adjusted. Logically, these operations occur on the “half-click,” that is, upon the initial toggle of an input key, such as a mouse or keyboard button. The search is initiated (block 84) upon the next “half-click,” that is, upon the release of the input key, after which the search criteria is preprocessed to form tokens (block 85), as further described below with reference to FIG. 6. In one embodiment, proximity of search terms within each document is searched before inclusiveness, but the ordering of these operations could be reversed with no loss in generality. Thus, a proximity, or nearness, search is first performed (block 86), as further described below with reference to FIG. 7, and, if interim search results are generated, an inclusiveness search is performed (block 88), as further described below with reference to FIG. 8. If final search results are generated (block 89), the search results are presented to the user (block 90) for review or further searching.

Preprocessing a Search

Preprocessing a search primarily converts the data excerpt 51 into an equivalent tokenized representation for use in a search query. FIG. 6 is a flow diagram showing a routine 100 for preprocessing a search for use with the method 80 of FIG. 5. First, if required, the data excerpt 51 is parsed to identify tokens (block 101). Parsing is required for textual data excerpts, but may be unnecessary, by way of example, for search terms that already qualify as tokens, encapsulated search queries, or literal binary data. In one embodiment, stop words are first removed from the data excerpt 51 and tokens are extracted as noun phrases converted into root word stem form, although individual nouns or n-grams could be used in lieu of noun phrases. The noun phrases can be formed using, for example, the LinguistX product licensed by Inxight Software, Inc., Santa Clara, Calif. In a further embodiment, the stop words can be customized as using a user-editable list. In a still further embodiment, the search terms can be broadened or narrowed to identify one or more synonyms that are conjunctively included with the corresponding search term in a search query. The tokens are compiled into an initial search query (block 102) that can be further modified by the proximity and inclusiveness control inputs.

Searching by Nearness

The proximity control 53 selectively specifies a degree of nearness between matching search terms found in each document. FIG. 7 is a flow diagram showing a routine 110 for searching by nearness for use with the method 80 of FIG. 5. The “Proximity” control 53 allows a user to specify a span, or window, within each target document over which matching search terms must occur. The span size is defined as the distance between any two matching terms. If two terms occur next to each other, the span between the terms is zero. Thus, a minimum of two matching terms is required to form a span. A single matching term cannot create a span. In one embodiment, the “Proximity” control 53 is implemented as a slider bar that can vary between 0.0 and 1.0. At one extreme of the control range of the “Proximity” control 53, the span size can vary from the number of search terms specified, that is, from two search terms up to the number of search terms in the data excerpt 51, to the total number of matching terms occurring within each document at the other extreme of the control range.

A span size and a number of search terms to combine within the span are respectively determined from the “Proximity” control 53 input (blocks 111 and 112). Both the span s to be applied and the number of search terms to combine c during searching of each document are determined in accordance with equations (1) and (2):

$$\begin{matrix}s = int ( N * ( \frac{1}{{p}^{2}} - 1 ) ) & ( 1 ) \\ c = Max Int ( 2 , N * {p}^{2} ) & ( 2 )\end{matrix}$$

where N is a number of the tokens and 0.0<p<1.0 is a value representing the degree of nearness specified through the selectable “Proximity” control 53. The function MaxInt( ) ensures that a value not less than two for the matching search terms is specified. The search query is then executed on the target corpus conditioned on the span size and search terms number (block 113).

In one embodiment, the search terms are combined in the same ordering as provided in the data excerpt 51, which implicitly limits the universe of possible combinations of search terms. However, in a further embodiment, the ordering of the search terms in the data excerpt 51 is immaterial and a wider range of search term combinations can be considered.

Searching by Inclusion

The inclusiveness control selectively specifies a granularity of inclusion of search terms within each document. FIG. 8 is a flow diagram showing a routine 120 for searching by inclusion for use with the method 80 of FIG. 5. The “Contains” control 52 allows a user to specify that only those target documents containing a number of the search terms proportionate to the relative position of the control be returned as search results 56. In one embodiment, the “Contains” control 52 is implemented as a slider bar that can vary between 0.0 and 1.0. At one extreme of the control range of the “Contains” control 52, the number of included search terms, or “hits,” can vary from one search term to the total number of search terms in the data excerpt 51 at the other extreme of the control range. In one embodiment, setting the search terms number equal to one is equivalent to a Boolean OR operation and setting the search terms number equal to the total number of possible search terms is equivalent to a Boolean AND.

The number of search terms is determined from the “Contains” control 52 input (block 121). The number of search terms h that must be matched by one or more terms or concepts in each target document is determined in accordance with equation (3):
h=int(N*p+1) (3)
where N is a total number of the tokens and 0.0≦p<1.0 is a value representing the granularity of inclusiveness specified through the “Contains” control. The search query is then executed on the target corpus conditioned on the minimum number of hits (block 122).
System Modules

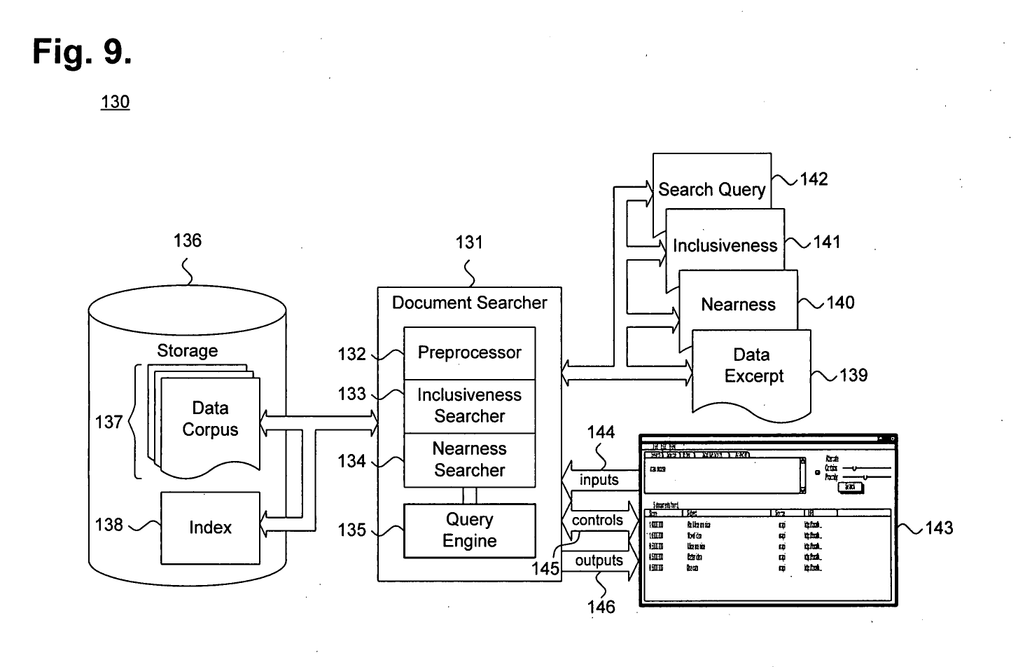

In one embodiment, searching is performed by the document searcher. FIG. 9 is a block diagram showing the system modules 130 for implementing the document searcher 131 of FIG. 1. The document searcher 131 operates in accordance with a sequence of process steps, as further described above with reference to FIG. 5.

The document searcher 131 includes a storage device 136 and a preprocessor 132, nearness searcher 133, and inclusiveness searcher 134. In addition, the document search 131 includes a query engine 135, or provides an interface to an external query engine 36 (shown in FIG. 1), which executes search queries on a local database 30 or remote database 37 for the document searcher 131. The storage device 136 maintains a corpus of target data 137, such as documents or files, and an associated index 138. Each target data has been previously evaluated to create an index 138, which can be used for searching, categorizing, and presenting information derived from the data corpus 137 through text or data analytics and similar tools.

The preprocessor 132 evaluates each data excerpt 139 as provided as an input 143 from a user interface 142 to build an initial search query 142. Based on the “Contains” control 52 inputs 144, the inclusiveness searcher 133 determines the minimum number of hits on search terms necessary for a target document in the data corpus 137 to match, which are saved as nearness parameters 140. Similarly, based on the “Proximity” control 53 inputs 144, the nearness searcher 134 determines both the search span size and the number of search terms to combine in each span, which are saved as inclusiveness parameters 140. The query engine 135 executes the search query 142 against the data corpus 137 and provides search results as outputs 146 that are presented through the user interface 143. Other forms of document searcher functionality are possible.

While the invention has been particularly shown and described as referenced to the embodiments thereof, those skilled in the art will understand that the foregoing and other changes in form and detail may be made therein without departing from the spirit and scope of the invention.

### APPENDIX

In one embodiment, inclusiveness and nearness, or proximity, searching are implemented using functionality provided by Lucene, a Java-based, open source toolkit for text indexing and searching, which is available over the Internet at http://lucene.apache.org. Other information libraries provide sufficient similar functionality.

Inclusiveness and nearness searching can be respectively defined as functions CONTAINS( ) and SPAN( ), providing functionality as follows:
(1) CONTAINS(term[ ], count): terms is an input vector of search terms. Finds the documents that contain count number of matching terms. Returns the list of documents that qualify.
(2) SPAN(term[ ], span): terms is an input vector of search terms. Finds the documents that contain matching terms within the given span. Returns a list of documents that qualify.
   Other functional definitions are possible.
   Example Search Query

Assuming that the data excerpt is textual data consisting of “cats and dogs at play.” The search tokens extracted from the data excerpt would be: cat, dog and play. The plural forms are made singular and the words and and at are removed as stop words.

CONTAINS( ) Searching

If the count input parameter is provided with a value of ‘2’ using the “Contains” control, an inclusiveness search query is compiled with the following form:

CONTAINS( [“cat”, “dog”, “play”], 2)

Thus, any documents that contain any combination of two or more of the search terms “cat,” “dog,” and “play” would be returned. The equivalent Boolean expression is:

(cat AND dog) OR (cat AND play) OR (dog AND play)

SPAN( ) Searching

The input parameters provided using the “Proximity” control modifies two possible controls, which are the size of the span, s, and the number of terms to combine, c, respectively determined per equations (1) and (2), described above. Using a parameter value of p=0.25, c=2, as at least two terms are required, and s=15. A nearness search query is compiled with the following form, using the SPAN( ) function in conjunction with Boolean operators:

SPAN([“cat”, “dog”], 15) OR SPAN([“cat”, “play”], 15) OR SPAN([“dog”, “play”], 15)

Thus, any documents that contain any combination of two or more of the search terms “cat,” “dog,” and “play” occurring within 15 terms of each other would be returned.

What is claimed is:

1. A system for formulating data search queries, comprising:
a user interface operable to specify an unstructured search criteria for a search query on one or more documents, comprising:
an input portal to receive a data excerpt selected to be searched against the documents;
a selectable inclusiveness control to specify a granularity of inclusion of matching tokens within each document;
a selectable proximity control to specify a degree of nearness of the tokens within each document; and
a document searcher to compile tokens derived from the data excerpt and parameters corresponding to the granularity of inclusion and the degree of nearness into the search query.

2. A system according to claim 1, further comprising:
a storage to maintain the target corpus comprising the documents indexed to facilitate searching; and
a search engine to execute the search query against the documents maintained in the target corpus, wherein search results identified by the search query execution are presented.

3. A system according to claim 1, further comprising:
a parser to extract the tokens from the data excerpt.

4. A system according to claim 1, wherein the granularity of inclusiveness on a continuum vary between a Boolean OR operation of all tokens and a Boolean AND operation of all tokens.

5. A system according to claim 1, wherein a number of tokens h that must be matched by one or more words in each target document are determined in accordance with the equation:
h=int(N*p+1)
where N is a total number of the tokens and 0.0≦p<1.0 is a value representing the granularity of inclusiveness specified through the selectable inclusiveness control.

6. A system according to claim 1, wherein the degree of nearness on a continuum vary between a span equal to a number of the tokens and a number of terms in each document.

7. A system according to claim 1, wherein a span s to be applied and a number of tokens to combine c during searching of each document are determined in accordance with the equations:
$$\begin{matrix}s = int ( N * ( \frac{1}{{p}^{2}} - 1 ) ) \\ c = Max Int ( 2 , N * {p}^{2} )\end{matrix}$$
where N is a number of the tokens and 0.0<p≦1.0 is a value representing the degree of nearness specified through the selectable proximity control.

8. A system according to claim 1, further comprising:
a document analyzer to assign weights to terms based on structural location within each document, wherein the search query terms are modified to favor the terms having higher weights over the terms having lower weights.

9. A system according to claim 8, wherein the higher weights are assigned to the terms occurring in a structural location selected from the group comprising titles, headings, tables of content, and indexes.

10. A system according to claim 1, further comprising:
a query processor to broaden the tokens, comprising:
a word analyzer to derive a normalized root stem for each token and to identify one or more synonyms for the normalized root stem, wherein the synonyms are conjunctively included with the token in the search query.

11. A system according to claim 1, further comprising:
a selection control operable to specify at least one of one or more required terms and one or more optional terms in the data excerpt, wherein the search query terms are modified to always include the required terms and to permissively include the optional terms.

12. A system according to claim 1, further comprising:
an ordering control operable to specify precedence of the tokens, wherein the search query terms are modified to favor the terms having higher precedence.

13. A system according to claim 1, further comprising:
a search scope control operable to specify documents to be searched, wherein the search query is modified to search the specified documents.

14. A system according to claim 1, wherein the selectable inclusiveness control and the selectable proximity control are provided as a one of single selectable controls or combined controls selected from the group comprising rotary or gimbal knobs, slider bars, radio buttons, and user input mechanisms that allow continuous or discrete selection over a fixed range of rotation, movement, or selection.

15. A system according to claim 1, wherein the data excerpt comprises at least one of textual data, binary data, and an encapsulated search query.

16. A method for formulating data search queries, comprising:
providing a user interface operable to specify an unstructured search criteria for a search query on one or more documents, comprising:
exporting an input portal to receive a data excerpt selected to be searched against the documents;
exporting a selectable inclusiveness control to specify a granularity of inclusion of matching tokens within each document;
exporting a selectable proximity control to specify a degree of nearness of the tokens within each document; and
compiling tokens derived from the data excerpt and parameters corresponding to the granularity of inclusion and the degree of nearness into the search query.

17. A method according to claim 16, further comprising:
maintaining the target corpus comprising the documents indexed to facilitate searching;
executing the search query against the documents maintained in the target corpus; and
presenting search results identified by the search query execution.

18. A method according to claim 16, further comprising:
extracting the tokens from the data excerpt.

19. A method according to claim 16, further comprising:
varying the granularity of inclusiveness on a continuum between a Boolean OR operation of all tokens and a Boolean AND operation of all tokens.

20. A method according to claim 16, further comprising:
determining a number of tokens h that must be matched by one or more words in each target document in accordance with the equation:
h=int(N*p+1)
where N is a total number of the tokens and 0.0≦p<1.0 is a value representing the granularity of inclusiveness specified through the selectable inclusiveness control.

21. A method according to claim 16, further comprising:
varying the degree of nearness on a continuum between a span equal to a number of the tokens and a number of terms in each document.

22. A method according to claim 16, further comprising:
determining a span s to be applied and a number of tokens to combine c during searching of each document in accordance with the equations:
$$\begin{matrix}s = int ( N * ( \frac{1}{{p}^{2}} - 1 ) ) \\ c = Max Int ( 2 , N * {p}^{2} )\end{matrix}$$
where N is a number of the tokens and 0.0<p≦1.0 is a value representing the degree of nearness specified through the selectable proximity control.

23. A method according to claim 16, further comprising:
assigning weights to terms based on structural location within each document; and
modifying the search query terms to favor the terms having higher weights over the terms having lower weights.

24. A method according to claim 23, wherein the higher weights are assigned to the terms occurring in a structural location selected from the group comprising titles, headings, tables of content, and indexes.

25. A method according to claim 16, further comprising:
broadening the tokens, comprising:
deriving a normalized root stem for each token;
identifying one or more synonyms for the normalized root stem; and
conjunctively including the synonyms with the token in the search query.

26. A method according to claim 16, further comprising:
exporting a selection control operable to specify at least one of one or more required terms and one or more optional terms in the data excerpt; and
modifying the search query terms to always include the required terms and to permissively include the optional terms.

27. A method according to claim 16, further comprising:
exporting an ordering control operable to specify precedence of the tokens; and
modifying the search query terms to favor the terms having higher precedence.

28. A method according to claim 16, further comprising:
exporting a search scope control operable to specify documents to be searched; and
limiting the search query to search the specified documents.

29. A method according to claim 16, further comprising:
providing the selectable inclusiveness control and the selectable proximity control as a one of single selectable controls or combined controls selected from the group comprising rotary or gimbal knobs, slider bars, radio buttons, and user input mechanisms that allow continuous or discrete selection over a fixed range of rotation, movement, or selection.

30. A method according to claim 16, wherein the data excerpt comprises at least one of textual data, binary data, and an encapsulated search query.

31. A computer-readable storage medium holding code for performing the method according to claim 16.

32. A system for performing a data search, comprising:
an input interface to process a data excerpt selected to be searched against one or more documents stored in electronic form into search terms;
a document searcher to build a search criteria containing the search terms and parameters indicating at least one of search term inclusion and proximity of matching search terms in the documents; and
an output interface to present search results generated by execution of the search criteria on the documents.

33. A system according to claim 32, wherein the search term inclusion varies on a continuum between a Boolean OR operation of all tokens and a Boolean AND operation of all tokens.

34. A system according to claim 32, wherein the proximity of matching search terms varies on a continuum between a span equal to a number of the search terms and a number of overall terms appearing in each document.

35. A system according to claim 34, wherein the data excerpt comprises at least one of textual data, binary data, and an encapsulated search query.

36. A system according to claim 32, wherein the documents are selected from the group comprising books, manuscripts, published materials, email, personal correspondence, notes, instant messaging, textual content, spreadsheets, databases, and object libraries.

37. A method for performing a data search, comprising:
processing a data excerpt selected to be searched against one or more documents stored in electronic form into search terms;
building a search criteria containing the search terms and parameters indicating at least one of search term inclusion and proximity of matching search terms in the documents; and
presenting search results generated by execution of the search criteria on the documents.

38. A method according to claim 37, further comprising:
varying the search term inclusion on a continuum between a Boolean OR operation of all tokens and a Boolean AND operation of all tokens.

39. A method according to claim 37, further comprising:
varying the proximity of matching search terms on a continuum between a span equal to a number of the search terms and a number of overall terms appearing in each document.

40. A method according to claim 39, wherein the data excerpt comprises at least one of textual data, binary data, and an encapsulated search query.

41. A method according to claim 37, wherein the documents are selected from the group comprising books, manuscripts, published materials, email, personal correspondence, notes, instant messaging, textual content, spreadsheets, databases, and object libraries.

42. A computer-readable storage medium holding code for performing the method according to claim 37.
